(19) United States
(12) Patent Application Publication
(10) Pub. No.: US 2003/0115297 A1
(43) Pub. Date: Jun. 19, 2003

(54) Object oriented framework mechanism and method for virtual dynamic cloning of computer systems in a network

(75) Inventors: Michael John Branson, Rochester, MN (US); Earl Walter Emerick, Rochester, MN (US); Raymond Keith Harney, Rochester, MN (US); Gregory Scott Hurlebaus, Rochester, MN (US)

Correspondence Address: MARTIN & ASSOCIATES, LLC, P O BOX 548, CARTHAGE, MO, 64836-0548, US

(73) Assignee: International Business Machines Corporation, Armonk, NY (US)

(21) Appl. No.: 10/023,544

(22) Filed: Dec. 17, 2001

(51) Int. Cl. G06F 15/177

(52) U.S. Cl. 709/220

(57) ABSTRACT

An object oriented framework defines a model computer system that can be used to configure computer systems on a network. The copying of configuration data for the model computer system to one or more other computer systems is referred to herein as “cloning.” The model computer system may be defined by a system administrator specifying configuration data, or by a system administrator selecting one computer system on the network as the model computer system. The framework may then be used to configure one or more selected computer systems on the network to be similar to the model computer system in one or more aspects. The framework mechanism of the invention defines a model class and a system replicator class that are core classes of the framework, and therefore cannot be modified by a user. The model class defines a model computer system with one or more aspects that may be configured. The system replicator class allows comparing configuration data from one computer system against the configuration data for the model computer system, and for updating the configuration data of one or more computer systems to match the configuration data for the model computer system. The framework mechanism also includes a user-extensible system aspect class that allows a user to define concrete subclasses that define aspects of computer systems on the network. Instances of the aspect class or its concrete subclasses define the configuration data that may be read and updated on computer systems on the network.

### BACKGROUND OF THE INVENTION

1. Technical Field

This invention generally relates to the data processing field. More specifically, this invention relates to configuring computer systems in a networked computing environment.

2. Background Art

Since the dawn of the computer age, computer systems have become indispensable in many fields of human endeavor including engineering design, machine and process control, and information storage and access. In the early days of computers, companies such as banks, industry, and the government would purchase a single computer which satisfied their needs, but by the early 1950's many companies had multiple computers and the need to move data from one computer to another became apparent. At this time computer networks began being developed to allow computers to work together.

Networked computers are capable of performing tasks that no single computer could perform. In addition, networks allow low cost personal computer systems to connect to larger systems to perform tasks that such low cost systems could not perform alone. Most companies in the United States today have one or more computer networks. The topology and size of the networks may vary according to the computer systems being networked and the design of the system administrator. It is very common, in fact, for companies to have multiple computer networks. Many large companies have a sophisticated blend of local area networks (LANs) and wide area networks (WANs) that effectively connect most computers in the company to each other. Most existing computer networks have a client-server architecture, where one or more server machines service requests from client machines (such as desktop computer systems).

Computer networks are typically managed by one or more “system administrators.” A system administrator is responsible for making sure the network runs smoothly. This means that a system administrator typically is responsible for many tasks, including: making hardware upgrades, installing new software on servers, installing software on client machines, setting security parameters for network resources, etc.

Often, it is desired to have many systems in a network that are “identical” to one another. No two systems can be 100% identical because each system requires some things to be unique, such as identity, network address, serial number, etc. There are some tools that exist that allow the entire image on a disk drive of one computer system to be copied to the disk drive of another computer system. This disk copying, however, requires that the computer system being copied to be “out of service” for the business. In other words, there are no known tools that allow a system administrator to easily change the configuration of a computer system on a network to match a model configuration while the computer system is running on the network. If computer systems need to be updated while they are running, the system administrator typically defines a model configuration on paper, then must access each individual computer system on the network, determine its configuration, compare the configuration to the desired model configuration, and change the configuration to match the model configuration. This is a time-consuming task, even for updating a single computer system, that is prone to human error. If dozens or hundreds of computer systems need to be updated, the task of the system administrator becomes very difficult, indeed. Because of the highly manual, time-consuming methods currently used to update computer systems on a network, by the time the system administrator updates the last computer system, the configuration of the first computer systems that were updated could have drastically changed. Without a mechanism and method for cloning certain aspects of a model computer system to other computer systems on a network in a quick and efficient manner, the computer industry will continue to suffer from inefficient ways of administrating the configuration of computer systems on computer networks.

### DISCLOSURE OF INVENTION

According to the preferred embodiments, an object oriented framework defines a model computer system that can be used to configure computer systems on a network. The copying of configuration data for the model computer system to one or more other computer systems is referred to herein as “cloning.” The model computer system may be defined by a system administrator specifying configuration data, or by a system administrator selecting one computer system on the network as the model computer system. The framework may then be used to configure one or more selected computer systems on the network to be similar to the model computer system in one or more aspects. The framework mechanism of the invention defines a model class and a system replicator class that are core classes of the framework, and therefore cannot be modified by a user. The model class defines a model computer system with one or more aspects that may be configured. The system replicator class allows comparing configuration data from one computer system against the configuration data for the model computer system, and for updating the configuration data of one or more computer systems to match the configuration data for the model computer system. The framework mechanism also includes a user-extensible system aspect class that allows a user to define concrete subclasses that define aspects of computer systems on the network. Instances of the aspect class or its concrete subclasses define the configuration data that may be read and updated on computer systems on the network.

The foregoing and other features and advantages of the invention will be apparent from the following more particular description of preferred embodiments of the invention, as illustrated in the accompanying drawings.

### BRIEF DESCRIPTION OF DRAWINGS

The preferred exemplary embodiments of the present invention will hereinafter be described in conjunction with the appended drawings, where like designations denote like elements, and:

FIG. 1 is a block diagram of a computer system according to a preferred embodiment of the present invention;

FIG. 2 is a flow diagram of a method for updating the configuration data of computer systems on a network in accordance with the preferred embodiments;

FIG. 3 is a class diagram showing classes that may be used to implement a portion of the system cloning framework of FIG. 1;

FIG. 4 is a class diagram showing classes that may be used to implement a portion of the system cloning framework of FIG. 1;

FIG. 5 is an object interaction diagram showing the steps in creating a model system object in accordance with the preferred embodiments; and

FIG. 6 is an object interaction diagram showing sample steps in cloning a computer system configuration to other computer systems on the network in accordance with one specific implementation of the preferred embodiments.

### BEST MODE FOR CARRYING OUT THE INVENTION

The present invention relates to object oriented programming techniques. For those individuals who are not generally familiar with object oriented programming, the Overview section below presents many of the concepts that will help to understand the invention.

1. Overview

Object Oriented Technology v. Procedural Technology

Object oriented programming is a method of implementation in which programs are organized as cooperative collections of objects, each of which represents an instance of some class, and whose classes are all members of a hierarchy of classes united via inheritance relationships. Object oriented programming differs from standard procedural programming in that it uses objects, not algorithms, as the fundamental building blocks for creating computer programs. This difference stems from the fact that the design focus of object oriented programming technology is wholly different than that of procedural programming technology.

The focus of procedural-based design is on the overall process that solves the problem; whereas, the focus of object oriented design is on how the problem can be broken down into a set of autonomous entities that can work together to provide a solution. The autonomous entities of object oriented technology are, of course, objects. Objects can be thought of as autonomous agents that work together to perform certain tasks. Said another way, object oriented technology is significantly different from procedural technology because problems are broken down into sets of cooperating objects instead of into hierarchies of nested computer programs or procedures.

Thus, a pure object oriented program is made up of code entities called objects. Each object is an identifiable, encapsulated piece of code that provides one or more services when requested by a client. Conceptually, an object has two parts, an external object interface and internal object data. In particular, all data is encapsulated by the object interface such that other objects must communicate with that object through its object interface. The only way to retrieve, process or otherwise operate on the encapsulated data is through the methods defined on the object. This protects the internal data portion of the object from outside tampering. Additionally, because outside objects have no access to the internal implementation of an object, that internal implementation can change without affecting other aspects of the program.

In this way, the object system isolates the requestor of services (client objects) from the providers of services (server objects) by a well defined encapsulating interface. Thus, in the classic object model, a client object sends request messages (e.g., method calls) to server objects to perform any necessary or desired function. The message identifies a particular server object and specifies what method is to be performed by the server object, and also supplies any required parameters. The server object receives and interprets the message, and can then determine what service to perform.

Because all operations on an object are expressed as methods called from one object to another, methods can be called by objects in other processes. Objects that reside in one process and that are capable of calling methods on an object in another process (such as a process on a remote computer system) are known as distributed objects.

Many distributed object systems allow interaction between objects in remote locations over a communications link. In a distributed object system a “client object” in one location calls methods on a “server object” in another location, which may be a remote location. The client object-server object interactions form the basis for the distributed object system.

Another central concept in object oriented programming is the class. A class is a template that defines a type of object. A class outlines the makeup of objects that belong to that class. By defining a class, objects can be created that belong to the class without having to rewrite the entire definition for each new object as it is created. This feature of object oriented programming promotes the reusability of existing definitions and promotes efficient use of program code.

There are many computer languages that presently support object oriented programming techniques. For example, Smalltalk, Object Pascal, C++ and Java are all examples of programming languages that support object oriented programming to one degree or another.

The goal of using object oriented programming is to create small, reusable sections of program code known as objects that can be quickly and easily combined and re-used to create new programs. This is similar to the idea of using the same set of building blocks again and again to create many different structures. The modular and re-usable aspects of objects will typically speed development of new programs, thereby reducing the costs associated with the development cycle. In addition, by creating and re-using a group of well-tested objects, a more stable, uniform, and consistent approach to developing new computer programs can be achieved.

Although object oriented programming offers significant improvements over other programming types, program development still requires significant amounts of time and effort, especially if no preexisting objects are available as a starting point. Consequently, one approach has been to provide a program developer with a set of pre-defined, interconnected classes that create a set of objects. Such pre-defined classes and libraries are typically called object frameworks. Frameworks essentially provide a prefabricated structure for a working program by defining certain classes, class relationships, and methods that a programmer may easily use by appropriate subclassing to generate a new object oriented program.

The Term Framework

There has been an evolution of terms and phrases which have particular meaning to those skilled in the art of OO design. However, the reader should note that one of loosest definitions in the OO art is the definition of the word framework. The word framework means different things to different people. Therefore, when comparing the characteristics of two supposed framework mechanisms, the reader should take care to ensure that the comparison is indeed “apples to apples.” As will become more clear in the forthcoming paragraphs, the term framework is used in this specification to describe an OO mechanism that has been designed to have core function and extensible function. The core function is that part of the framework mechanism that is not subject to modification by the framework purchaser (referred to herein as a “user”). The extensible function, on the other hand, is that part of the framework mechanism that has been explicitly designed to be customized and extended by the user. Note that the term “core function” is described in the specification and claims as functions that cannot be modified by a user. However, because a function is a core function does not mean that a user is somehow prevented from modifying it. A user could use class replacement, for example, to replace core classes in a framework. However, the design of the framework intends that certain classes and class relationships remain undisturbed by the user, and these functions comprise the “core functions” of a framework. Thus, when core functions are described in a way that they “cannot be modified by a user”, this means that the core functions cannot be modified by a user within the design parameters of the framework.

Object Oriented Frameworks

Object oriented frameworks are prefabricated structures of classes and class relationships that allow a programmer to extend the framework to build an object oriented program that performs desired functions. While in general terms an object oriented framework can be properly characterized as an object oriented (“OO”) solution, there is nevertheless a fundamental difference between a framework and a traditional OO program. The difference is that frameworks are designed in a way that permits and promotes customization and extension of certain aspects of the solution. In other words, framework mechanisms amount to more than just a solution to the problem. The mechanisms provide a living solution that can be customized and extended to address individualized requirements that change over time. Of course, the customization/extension quality of framework mechanisms is extremely valuable to purchasers (referred to herein as framework consumers) because the cost of customizing or extending a framework is much less than the cost of replacing or reworking an existing solution.

Therefore, when framework designers set out to solve a particular problem, they do more than merely design individual objects and how those objects interrelate. They also design the core function of the framework (i.e., the part of the framework that should not be subject to potential customization and extension by the framework consumer) and the extensible function of the framework (i.e., that part of the framework that is to be subject to potential customization and extension.).

Notation

There is, as yet, no uniformly accepted notation for communicating object oriented programming ideas. The notation used in this specification is very similar to that known in the programming industry as Booch notation, after Grady Booch. Mr. Booch is the author of Object-Oriented Analysis and Design With Applications, 2nd ed. (1994), available from The Benjamin/Cummings Publishing Company, Inc. Use of Booch notation concepts within this specification should not be taken to imply any connection between the inventors and/or the assignee of this patent application and Mr. Booch or Mr. Booch's employer. The notational system used by Mr. Booch is more fully explained at Chapter 5, pp. 171-228 of the aforementioned book. The notational system used herein will be explained generally below. Other notational conventions used herein will be explained as needed.

2. Detailed Description

An object oriented framework mechanism and method in accordance with the preferred embodiments defines a model computer system that contains configuration data. The model computer system may be defined by a user, or may be selected from an existing computer system on the network. The framework includes core and extensible function that allows comparing the configuration data from one or more selected computer systems to the configuration data for the model computer system, and for updating the configuration data for the selected computer system(s) to match the configuration data for the model computer system.

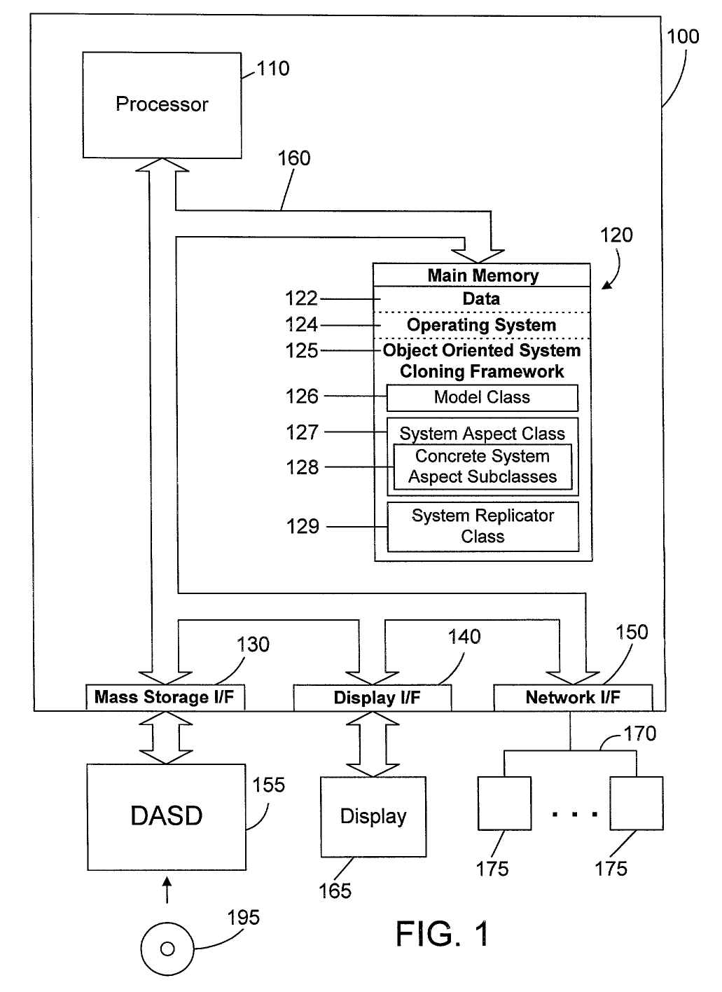

Referring to FIG. 1, a computer system 100 is one suitable implementation of a computer system (or apparatus) in accordance with the preferred embodiments of the invention. Computer system 100 is an IBM iSeries computer system. However, those skilled in the art will appreciate that the mechanisms and apparatus of the present invention apply equally to any computer system, regardless of whether the computer system is a complicated multi-user computing apparatus. a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD ROM drive, which may store data to and read data from a CD ROM 195.

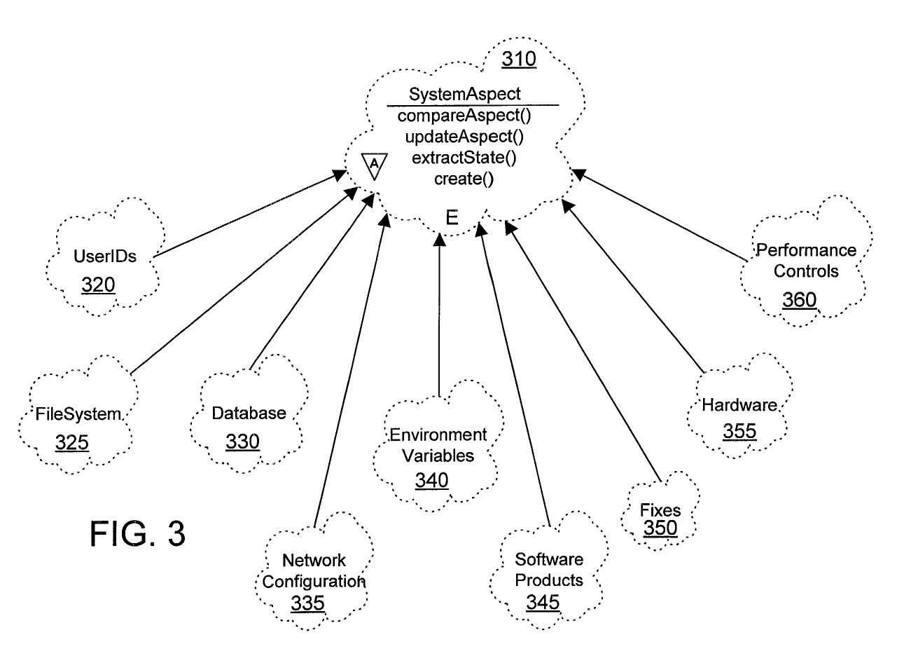

Main memory 120 in accordance with the preferred embodiments contains data 122, an operating system 124, and an object oriented system cloning framework mechanism 125. System cloning framework mechanism 125 includes a model class 126, a system aspect class 127, and a system replicator class 129. Model class 126 and system replicator class 129 are preferably core functions of the framework 125 that cannot be modified by a user. System aspect class 127 is an extensible class that allows a user to define one or more concrete system aspect subclasses 128. The specific concrete system aspect subclasses 128 that are required depend on the type of computer system (i.e., platform) being configured. The model class 126, system aspect class 127, concrete system aspect subclasses 128, and system replicator class 129 are discussed in more detail below with reference to FIGS. 3-6.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 122, operating system 124, and framework 125 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Data 122 represents any data that serves as input to or output from any program in computer system 100. Operating system 124 is a multitasking operating system known in the industry as OS/400; however, those skilled in the art will appreciate that the spirit and scope of the present invention is not limited to any one operating system.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 124. Operating system 124 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM (e.g., 195 of FIG. 1), and transmission type media such as digital and analog communications links.

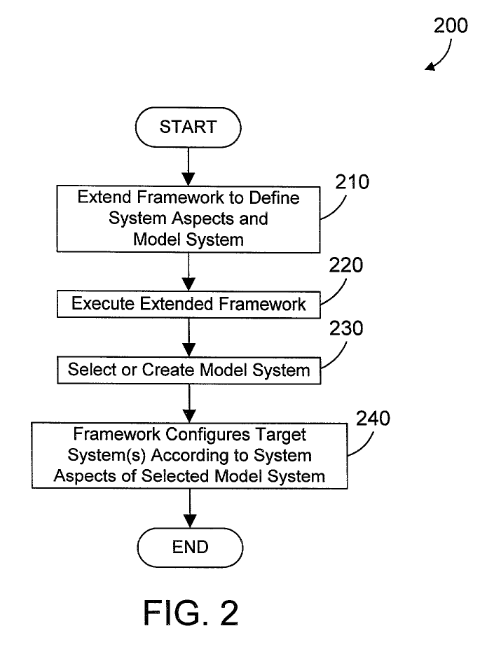

Referring now to FIG. 2, a method 200 in accordance with the preferred embodiments begins by extending the framework to define system aspects and the model system (step 210). Referring back to FIG. 1, this step 210 includes the definition of the concrete system aspect subclasses 128. These concrete system aspect subclasses 128 define configuration data for the platform that corresponds to the type of computer systems on the network that need to be configured, or define a superset of configuration data across multiple platforms. Once the framework is properly extended in step 210, the extended framework is executed (step 220). The executing framework allows a system administrator to select or create a model system (step 230). A model system is selected when one of the computer systems on the network is identified as the model system. A model system is created when a set of configuration data is defined. A suitable set of configuration data could be defined by a system administrator using an editor, by a system administrator using a graphical user interface to select different configuration data and their values, or by a system administrator selecting values extracted from a running system to use as a model. Once the model system has been defined in step 230, the executing framework may be used to clone the model system to other computer systems on the network (referred to in FIG. 2 as “Target Systems”) (step 240). This cloning means that the configuration data for the model system, which comprises system aspects for the model system, will be used to configure other selected computer systems on the network in a similar manner.

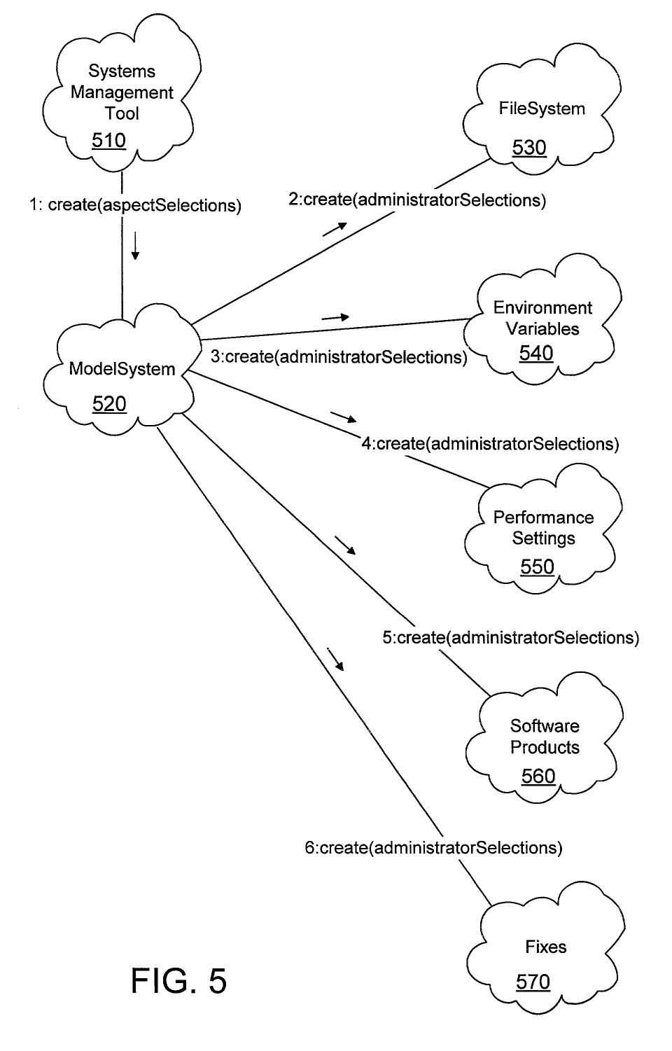

It is important to note that only the system aspects specified in the model computer system are cloned to the other selected computer systems. This allows great flexibility in defining a model computer system in a way that will perform needed maintenance on specified system aspects without interfering with other system aspects that need not be affected by the change. The selective nature of defining the model computer system is described in more detail below with respect to FIG. 5.

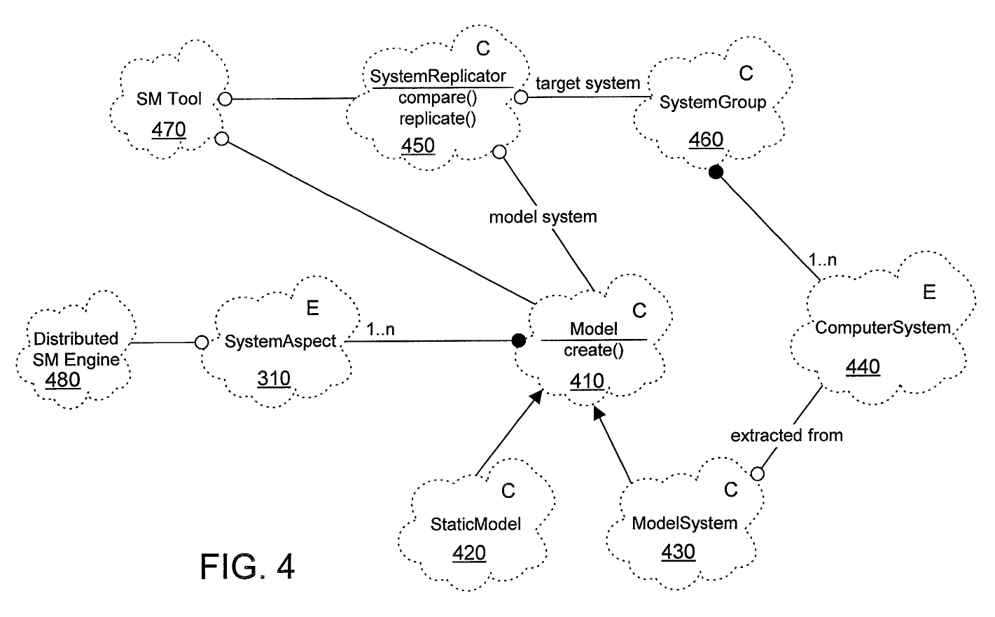

FIGS. 3 and 4 together comprise a class diagram for one specific implementation of a system cloning framework mechanism in accordance with the preferred embodiments. Referring to FIG. 3, a SystemAspect class 310 is an abstract, extensible class that defines several object methods, including compareAspect( ), updateAspect( ), extractState( ), and create( ). The compareAspect( ) method compares the system aspect of one or more selected computer systems with the corresponding system aspect in the model computer system. The updateAspect( ) method is invoked to update the system aspect on one or more selected computer system to match the system aspect specified in the model computer system. The extractState( ) method is invoked to extract the state (i.e., configuration data) from a selected computer system, in order to use the selected computer system as the model computer system. The create( ) method is a constructor that creates an instance of the SystemAspect class (or concrete subclass).

The SystemAspect class 310 in FIG. 3 is marked with an “E”, indicating that this class is an extensible class of the framework. The class is also abstract, meaning that the implementation of the defined methods must be provided in the concrete subclasses. FIG. 3 shows several suitable examples of system aspects that may need to be configured on a network. These system aspects are defined as concrete subclasses of the SystemAspect class 310, and include: UserIDs 320; FileSystem 325; Database 330; NetworkConfiguration 335; EnvironmentVariables 340; SoftwareProducts 345; Fixes 350; Hardware 355; and PerformanceControls 360. These system aspects shown in FIG. 3 are shown by way of example of suitable system aspects that may need to be configured on a computer system by a system administrator. Of course, other systems aspects not shown in FIG. 3 are also within the scope of the preferred embodiments, which expressly extends to any feature, parameter, system setting, or other system aspect that may need to be configured on a computer system by a system administrator.

The class diagram 400 of FIG. 4 shows the classes of one implementation of the framework in accordance with the preferred embodiments, with the concrete subclasses of SystemAspect (shown in FIG. 3) not shown in FIG. 4 for the purpose of clarity. The SystemAspect class 310 has a “using” relationship with a Distributed SM Engine class 480, which represents any suitable distributed system management engine, including those known in the art. The Distributed SM Engine class is used by the SystemApect class 310 to retrieve specified system aspects from computer systems on the network, and to update those system aspects. A model class 410 defines a model computer system, and includes a create( ) constructor method for creating an instance of the model class. The model class 410 contains 1−n instances of the SystemAspect class 310, which means that the model is comprised of a collection of system aspect objects. The model class 410 has two subclasses, StaticModel 420 and ModelSystem 430. StaticModel 420 represents a model computer system that is defined by entering or selecting configuration data for a computer system. In the preferred embodiments, a system administrator uses a graphical user interface to define the StaticModel. ModelSystem 430, in contrast, is a model that is defined by selecting a computer system on the network, and extracting its configuration data (also referred to herein as “state”). This selection of an existing computer system on the network as the model computer system may also be performed using a graphical user interface. The computer system selected as the model system is then used as a pattern for updating other computer systems on the network. This allows a system administrator to make changes to a single computer system, and when the configuration of the computer system has been verified and tested, its settings may then be cloned to other computer systems on the network. Note in FIG. 4 that ModelSystem 430 uses (is extracted from) the ComputerSystem class 440, indicating that the ModelSystem is extracted from one of the existing computer systems on the network.

A SystemReplicator class 450 provides a compare( ) method that allows comparing one or more system aspects of a target system with corresponding system aspect(s) of the model system, and provides a replicate( ) method that updates the configuration data (i.e., specified system aspects) for one or more target systems with corresponding configuration data from the model system. The SystemReplicator class 450 has a using relationship with the Model class 410 and with the SystemGroup class 460. SystemGroup 460 is a class that represents a group of 1−n computer systems on a network (represented by the “contains” relationship between SystemGroup 460 and ComputerSystem 440).

The class diagram 400 of FIG. 4 also includes an SM Tool class 470 that represents a system management tool that may use the SystemReplicator class 450 and the Model class 410. The SM Tool class 470 is a generic representation of any suitable system management tool that is capable of invoking methods on the SystemReplicator class 450 and on the Model class 410. In other words, SM Tool class 470 generically represents any code that is capable of using the framework of the preferred embodiments by invoking the create( ) method on the Model class to define a model computer system, and by invoking the compare( ) method on the SystemReplicator class to determine which target systems required updating, and by invoking the replicate( ) method on the SystemReplicator class to update the specified target systems with the configuration data (i.e., system aspects) specified in the model.

FIG. 4 includes designators “E” and “C” on the framework classes, with the “E” indicating a user-extensible class, while a “C” indicates a core class of the framework that cannot be modified by a user. The SystemAspect class 310 and the ComputerSystem class 440 are user-extensible classes, while the Model class 410, StaticModel class 420, ModelSystem class 430, SystemReplicator class 450, and SystemGroup class 460 are core classes of the framework, and therefore cannot be modified by a user. Note that SM tool 470 and Distributed SM Engine 480 are portions of code that invoke methods on the system cloning framework and that are invoked by methods on the framework, but are preferably not part of the framework itself.

The function of the system cloning framework mechanism 125 shown in FIG. 1 and represented by the class diagrams of FIGS. 3 and 4 is best understood with reference to object interaction diagrams for specific examples. Referring to FIG. 5, an object interaction diagram 500 shows one example of how a model system is created in accordance with the preferred embodiments. A systems management tool object 510 represents a software tool (i.e., code) that wants to define a static model system. The systems management tool object 510 invokes the create( ) constructor method on the ModelSystem class, passing aspectSelections as a parameter to the call (step 1). In response, the ModelSystem object 520 is created. We assume for this example that aspectSelections specifies the following system aspects: file system, environment variables, performance settings, software products, and fixes. Once the ModelSystem object 520 is created, it invokes the create( ) constructor method on each class corresponding to the specified system aspects. Step 2 creates the FileSystem object 530. Step 3 creates the EnvironmentVariables object 540. Step 4 creates the PerformanceSettings object 550. Step 5 creates the SoftwareProducts object 560. And step 6 creates the Fixes object 570. Note that the create( ) constructor method for each of these concrete subclasses of SystemAspect include a parameter administratorSelections that tells the object being created the value of the system aspects to include in the model system. The administratorSelections may be defined statically, or may be defined by a user interacting with a graphical user interface to define or select appropriate system aspects to include in the model system. The object interaction diagram 500 of FIG. 5 is shown as one specific example that illustrates how a ModelSystem may be created that includes a variety of different system aspects.

One of the significant advantages of the system cloning framework of the preferred embodiments is the flexibility to define any system aspect or combination of system aspects as a model system. This flexibility allows a system administrator to define a model system in any suitable manner. If only one change is needed to computer systems on the network, such as a software fix, a model computer system may be defined that only includes a single system aspect that corresponds to the fix. If many changes are needed, a more complex model may be defined that includes many system aspects. The significance of the model is that only those system aspects specified in the model are considered. All system aspects not specified in the model are not considered. In this manner a system model can be defined to accomplish any needed update to configuration data on computer systems on a network. For the ModelSystem shown in FIG. 5, only the included system aspect objects, i.e., FileSystem 530, EnvironmentVariables 540, PerformanceSettings 550, SoftwareProducts 560, and Fixes 570 are part of the model system.

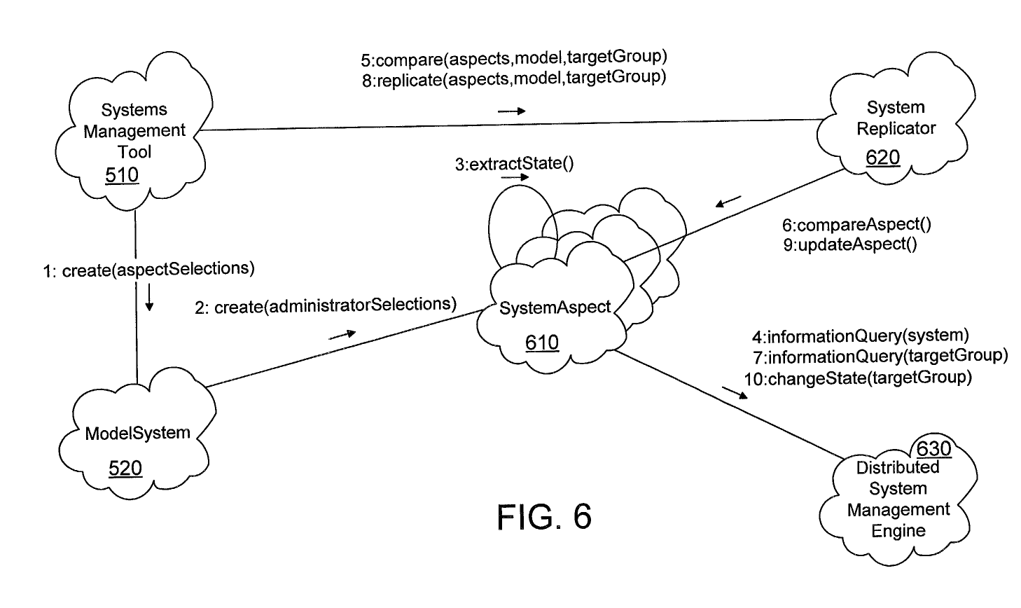

Referring now to FIG. 6, an object interaction diagram 600 shows the interaction between objects when an existing system is selected as the model system, and a target group of computer systems are updated according to the configuration data (i.e., system aspects) in the model system. First, a systems management tool object 510 invokes the create( ) constructor method on the ModelSystem class 520 (step 1). In response, the ModelSystem object 520 is created, and the create( ) constructor on the concrete subclasses specified in the administratorSelections parameter are invoked to create the appropriate SystemAspect objects 610 for the ModelSystem 520 (step 2). Note that step 2 is repeated for each concrete subclass of the SystemAspect class that is specified in the administratorSelections parameter, similar to steps 2-6 of FIG. 5. We assume that the administratorSelections parameter also specifies a particular target system as the model system. In this case, the extractState( ) method on each SystemAspect object 610 is invoked (step 3). In response, each SystemAspect object 610 invokes an informationQuery( ) method on the Distributed System Management Engine object 630, passing the system that is identified as the model system as a parameter (step 4). In response, the Distributed System Management Engine object 630 returns to the SystemAspect object 610 the value of that system aspect in the selected model system. Steps 3 and 4 are repeated for each SystemAspect object 610 until all contain configuration data corresponding to the identified target system that was selected as the model system. This collection of configuration data in the SystemAspect objects 610 that are contained by the ModelSystem object 520 defines the overall configuration data for the model system that is of interest.

Once the ModelSystem object 520 has been built, with its appropriate contained SystemAspect objects 610 with their values extracted from the selected model computer system on the network, the systems management tool object 510 invokes the compare( ) method on the system replicator object 620 (step 5). In response, the SystemReplicator object 620 invokes the compareAspect( ) method on each SystemAspect object 610 in the ModelSystem 520. This causes each SystemAspect object 610 to invoke an informationQuery( ) method on the Distributed System Management Engine object 630, passing targetGroup as a parameter to the call (step 7). TargetGroup specifies the group of computer systems on the network that are selected. In response to the informationQuery( ) method being invoked in step 7, the Distributed System Management Engine object 630 returns the value of the system aspect for each of the computer systems in the targetGroup. The comparing of system aspects in the ModelSystem object 520 to the selected computer systems in the targetGroup in steps 5-7 allows the Systems Management Tool object 510 to determine whether updates to all of the computer systems in the targetGroup are required. We assume for this example that all of the computer systems in the targetGroup need to be updated. As a result, the Systems Management Tool object 510 invokes the replicate( ) method on the SystemReplicator object 620 (step 8). In response, the SystemReplicator object 620 invokes the updateAspect( ) method on each SystemAspect object 610 in the ModelSystem 520 (step 9). In response, each SystemAspect object 610 invokes the changeState( ) method on the Distributed System Management Engine object 630, which then performs the update of configuration data specified in the SystemAspect object 610 for each computer system in the targetGroup.

The Systems Management Tool object 510 and the Distributed System Management Engine object 630 are shown in FIGS. 5 and 6 as single objects for the sake of simplicity. In reality, these objects are representative of any suitable code that may call object methods in the framework and that may be called by object methods in the framework.

Note that the examples presented herein are extremely simplified to illustrate some of the pertinent aspects of the framework of the present invention. Many changes, variations, and enhancements to the embodiments herein are possible within the scope of the present invention. The present invention expressly extends to any and all implementations of an object oriented framework that define a model system that contains configuration data, and that automatically updates one or more target systems using configuration data from the model system.

The preferred embodiments herein provide a system cloning framework that allow a system administrator to define a model system, either using an editor or graphical user interface to define configuration data, or by selecting an existing computer system as the model system. The system cloning framework may then be invoked, passing the model system and all selected systems for updating as parameters to the call, which results in the framework mechanism updating the configuration data of the selected systems according to the configuration data for the model system. In this way, systems aspects of a model computer system may be automatically replicated or “cloned” to the selected computer systems easily and efficiently.

The embodiments and examples set forth herein were presented in order to best explain the present invention and its practical application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the forthcoming claims.

What is claimed is:

1. A computer system comprising:
at least one processor;
a memory coupled to the at least one processor;
a network interface coupled to the at least one processor, the network interface coupling the computer system to a plurality of other computer systems via a network;
an object oriented framework mechanism residing in the memory and executed by the at least one processor, the framework mechanism comprising a cloning mechanism that replicates configuration data for a model computer system to at least one of the plurality of other computer systems.

2. The computer system of claim 1 wherein the cloning mechanism comprises a first portion that cannot be modified by a user and a second portion that is extensible by the user.

3. The computer system of claim 2 wherein the first portion comprises a model class that defines a model object that corresponds to the model computer system and that contains the configuration data for the model computer system.

4. The computer system of claim 3 wherein the model object comprises configuration data that is defined by a user using a graphical user interface.

5. The computer system of claim 3 wherein the model object comprises configuration data that corresponds to configuration data in a selected one of the plurality of other computer systems that is selected by a user.

6. The computer system of claim 2 wherein the second portion comprises a system aspect class that defines at least one system aspect object that defines at least one attribute of a computer system.

7. The computer system of claim 6 wherein the at least one attribute is selected from the group comprising:
user IDs, file system, database, network configuration, environment variables, software products, fixes, hardware, and performance controls.

8. The computer system of claim 2 wherein:
the first portion comprises a model class that defines a model object that corresponds to the model computer system and that contains the configuration data for the model computer system;
the second portion comprises a system aspect class that defines at least one system aspect object that defines at least one attribute of a computer system; and
the configuration data in the model object comprises a collection of system aspect objects.

9. The computer system of claim 2 wherein the first portion comprises a system replicator class that defines at least one system replicator object that compares the configuration data in the model object to configuration data from at least one of the plurality of other computer systems, and that replicates the configuration data from the model object to the at least one of the plurality of other computer systems.

10. A computer system comprising:
at least one processor;
a memory coupled to the at least one processor;
an object oriented framework mechanism residing in the memory and executed by the at least one processor, the framework mechanism comprising:
at least one object oriented model class that cannot be modified by a user, the model class defining at least one model object that defines configuration data for a model computer system;
at least one system aspect class that is extensible by a user, the system aspect class defining at least one system aspect object that defines at least one attribute of a computer system, wherein the configuration data in the model object comprises a collection of system aspect objects; and
at least one system replicator class that cannot be modified by a user, the system replicator class defining at least one system replicator object that compares the configuration data in the model object to configuration data from at least one selected computer system, and that replicates the configuration data from the model object to the at least one selected computer system.

11. A method for changing the configuration of at least one selected computer system on a network, the method comprising the steps of:
(1) providing an object oriented framework mechanism comprising a cloning mechanism that replicates configuration data for a model computer system to at least one selected computer system;
(2) extending at least one extensible portion of the framework mechanism to define at least one system aspect for each selected computer system;
(3) executing the extended framework mechanism;
(4) defining configuration data for a model computer system; and
(5) the executing framework mechanism updating configuration data for each selected computer system according to the defined configuration data for the model computer system.

12. The method of claim 11 wherein the executing framework mechanism compares the configuration data for each selected computer system with the defined configuration data for the model computer system to determine for which selected computer system step (5) is required.

13. The method of claim 11 wherein step (4) comprises the step of a user defining at least one system aspect using a graphical user interface.

14. The method of claim 11 wherein step (4) comprises the step of a user selecting one computer system on the network as the model computer system, wherein the configuration data for the selected one computer system is the source of configuration data for the model computer system.

15. A method for changing the configuration of at least one selected computer system on a network, the method comprising the steps of:
(1) providing an object oriented framework mechanism comprising:
(1A) a model class that cannot be modified by a user, the model class defining at least one model object that defines configuration data for a model computer system;
(1B) a system aspect class that is extensible by a user, the system aspect class defining at least one system aspect object that defines at least one attribute of a computer system, wherein the configuration data in the model object comprises a collection of system aspect objects; and
(1C) a system replicator class that cannot be modified by a user, the system replicator class defining at least one system replicator object that compares the configuration data in the model object to configuration data from at least one selected computer system, and that replicates the configuration data from the model object to the at least one selected computer system;
(2) extending the system aspect class of the framework mechanism to define at least one system aspect for each selected computer system;
(3) executing the extended framework mechanism;
(4) defining configuration data for a model computer system; and
(5) the executing framework mechanism updating configuration data for each selected computer system according to configuration data in the model object.

16. The method of claim 15 wherein the executing framework mechanism compares the configuration data for each selected computer system with the defined configuration data for the model computer system to determine for which selected computer system step (5) is required.

17. The method of claim 15 wherein step (4) comprises the step of a user defining at least one system aspect using a graphical user interface.

18. The method of claim 15 wherein step (4) comprises the step of a user selecting one computer system on the network as the model computer system, wherein the configuration data for the selected one computer system is the source of configuration data for the model computer system.

19. A program product comprising:
(1) an object oriented framework mechanism comprising a cloning mechanism that replicates configuration data for a model computer system to at least one of the plurality of other computer systems; and
(2) computer readable signal bearing media bearing the framework mechanism.

20. The program product of claim 19 wherein the signal bearing media comprises recordable media.

21. The program product of claim 19 wherein the signal bearing media comprises transmission media.

22. The program product of claim 19 wherein the cloning mechanism comprises a first portion that cannot be modified by a user and a second portion that is extensible by the user.

23. The program product of claim 22 wherein the first portion comprises a model class that defines a model object that corresponds to the model computer system and that contains the configuration data for the model computer system.

24. The program product of claim 23 wherein the model object comprises configuration data that is defined by a user using a graphical user interface.

25. The program product of claim 23 wherein the model object comprises configuration data that corresponds to configuration data in a selected one of the plurality of other computer systems that is selected by a user.

26. The program product of claim 22 wherein the second portion comprises a system aspect class that defines at least one system aspect object that defines at least one attribute of a computer system.

27. The program product of claim 26 wherein the at least one attribute is selected from the group comprising:
user IDs, file system, database, network configuration, environment variables, software products, fixes, hardware, and performance controls.

28. The program product of claim 22 wherein:
the first portion comprises a model class that defines a model object that corresponds to the model computer system and that contains the configuration data for the model computer system;
the second portion comprises a system aspect class that defines at least one system aspect object that defines at least one attribute of a computer system; and
the configuration data in the model object comprises a collection of system aspect objects.

29. The program product of claim 22 wherein the first portion comprises a system replicator class that defines at least one system replicator object that compares the configuration data in the model object to configuration data from at least one of the plurality of other computer systems, and that replicates the configuration data from the model object to the at least one of the plurality of other computer systems.

30. A program product comprising:
(1) an object oriented framework mechanism comprising:
(1A) at least one object oriented model class that cannot be modified by a user, the model class defining at least one model object that defines configuration data for a model computer system;
(1B) at least one system aspect class that is extensible by a user, the system aspect class defining at least one system aspect object that defines at least one attribute of a computer system, wherein the configuration data in the model object comprises a collection of system aspect objects; and
(1C) at least one system replicator class that cannot be modified by a user, the system replicator class defining at least one system replicator object that compares the configuration data in the model object to configuration data from at least one selected computer system, and that replicates the configuration data from the model object to the at least one selected computer system; and
(2) computer readable signal bearing media bearing the framework mechanism.

31. The program product of claim 30 wherein the signal bearing media comprises recordable media.

32. The program product of claim 30 wherein the signal bearing media comprises transmission media.
